(19) United States
(12) Patent Application Publication
(10) Pub. No.: US 2015/0071492 A1
(43) Pub. Date: Mar. 12, 2015

(54) ABNORMAL BEHAVIOUR DETECTION

(71) Applicant: BAE SYSTEMS plc, London (GB)

(72) Inventors: Jordi McGregor Barr, Bristol South Gloucestershire (GB); Yoann Paul Georges Thueux, Bristol South Gloucestershire (GB); Mark Robert Goodall, Bristol South Gloucestershire (GB)

(73) Assignee: BAE SYSTEMS plc, London (GB)

(21) Appl. No.: 14/397,340

(22) PCT Filed: Apr. 26, 2013
(86) PCT No.: PCT/GB2013/051062

§ 371 Date: Oct. 27, 2014

(30) Foreign Application Priority Data
Apr. 28, 2012 (GB) 1207704.6

(51) Int. Cl. G08B 13/196; G06N 99/00; G06N 7/00; G06T 7/20

(52) U.S. Cl. CPC G08B 13/19608; G08B 13/19613; G06T 7/20; G06N 99/005; G06N 7/005; G06T 2207/20076; G06T 2207/20081; G06T 2207/30196; G06T 2207/30232
USPC 382/103

(57) ABSTRACT

Methods and apparatus for determining whether a provided object track (24) is abnormal, an object track (24) being a set of values of a physical property of an object (2) measured over a period of time, the method comprising: providing a model comprising one or more functions (26), each function (26) being representative of an object track (24) that is defined to be normal; assigning the provided object track (24) to a function (26); and comparing the provided object track (24) to the assigned function (26) to determine whether that object track (24) is abnormal. Providing the model comprises: for each of a plurality of objects (2), determining an object track (24), wherein the determined object tracks (24) are defined as normal object tracks (24); and using the determined tracks (24), performing a Gaussian Processes based Variational Bayes Expectation Maximisation process to learn the one or more functions (26).

### FIELD OF THE INVENTION

The present invention relates to the detection of abnormal behaviour.

### BACKGROUND

Surveillance datasets (e.g. closed-circuit television footage of a scene under surveillance) tend to contain hours of data representing normal activity (e.g. normal human activity). The detection, by a human analyst, of a person behaving in an abnormal or unusual way (e.g. a person moving along an abnormal or unusual path) using such surveillance datasets tends to be difficult. This tends to be due to the relatively short attention spans of most humans.

### SUMMARY OF THE INVENTION

The present inventors have realised that automatic and unsupervised learning methods/algorithms may be used to model normality (i.e. normal behaviour). Also, the present inventors have realised that such models of normality may be used to indicate, e.g. to a human operator, that a deviation from normality has been observed.

In a first aspect, the present invention provides a method of determining whether a provided object track is an abnormal object track, an object track being a set of values of one or more physical properties of an object measured over a period of time, a physical property of an object being any property that is measurable whose value describes the object's state, the method comprising: providing a model, the model comprising one or more functions, each function being representative of an object track that is defined to be normal, assigning the provided object track to a function, and comparing the provided object track to the function to which it has been assigned to determine whether or not that object track is an abnormal object track, wherein the step of providing the model comprises: for each of a plurality of objects, determining an object track, wherein the determined object tracks are defined as normal object tracks, and using the determined object tracks, performing a Gaussian Processes based Variational Bayes Expectation Maximisation process to determine the one or more functions, each function being representative of one or more of the determined object tracks, the functions forming the model.

Determining an object track for an object may comprise performing a tracking algorithm to track that object over the period of time.

The tracking algorithm may be performed using measurements, taken over the period of time, of the one or more physical properties of each of the plurality of objects. Each measurement may be a measurement selected from the group of measurements consisting of: camera images, Automatic Identification System data, Global Positioning System data, and radar images.

Each of the objects may be a person, an animal, an aircraft, or a ship.

A physical property may be any of the following physical properties: absorption, albedo, angular momentum, area, brittleness, boiling point, capacitance, colour, concentration, density, dielectric, ductility, distribution, efficacy, elasticity, electric charge, electrical conductivity, electrical impedance, electric field, electric potential, emission, flexibility, flow rate, fluidity, frequency, hardness, inductance, intrinsic impedance, intensity, irradiance, length, location, luminance, luminescence, luster, malleability, magnetic field, magnetic flux, mass, melting point, moment, momentum, opacity, permeability, permittivity, plasticity, pressure, radiance, solubility, specific heat, resistivity, reflectivity, refractive index, spin, speed, strength, stiffness, temperature, tension, thermal conductivity, velocity, viscosity, volume, and wave impedance.

The step of performing a Gaussian Processes based Variational Bayes Expectation Maximisation process may comprise rotating and rebinning the object track data.

The step of comparing may comprise, using the provided object track and the function to which it has been assigned, determining a score value that is indicative of how abnormal the provided object track is relative to the function to which it has been assigned. The step of determining the score value may comprise determining the Mahalanobis distance between the provided object track and the function to which it has been assigned.

The method may further comprise displaying the provided object track with an image opacity that is dependent how abnormal the provided object track is relative to the function to which it has been assigned.

In a further aspect, the present invention provides a method of determining whether an object is behaving abnormally, the method comprising: tracking the object to produce an object track, an object track being a set of values of one or more physical properties of an object measured over a period of time, a physical property of an object being any property that is measurable whose value describes the object's state, and determining whether the produced object track is an abnormal object track using a method according to any of the above aspects, thereby determining whether the object is behaving abnormally.

In a further aspect, the present invention provides a method of determining a model of normal object behaviour, the model being for use in a method of detecting abnormal object behaviour, the method comprising: for each of a plurality of objects, over a period of time, measuring values of one or more physical properties of an object, a physical property of an object being any property that is measurable whose value describes the object's state, using some or all of the measurements, for each object, determining an object track, an object track being a set of values of the one or more physical properties of an object measured over the period of time, wherein the determined object tracks are defined as normal object tracks, and, using the determined object tracks, performing a Gaussian Processes based Variational Bayes Expectation Maximisation process to determine the one or more functions, each function being representative of one or more of the object tracks, the functions forming the model.

Determining an object track for an object may comprise performing a tracking algorithm to track that object over the period of time.

The tracking algorithm may be performed using measurements, taken over the period of time, of the one or more physical properties of each of the plurality of objects. Each measurement may be a measurement selected from the group of measurements consisting of: camera images, Automatic Identification System data, Global Positioning System data, and radar images.

Each of the objects may be an object selected from the group of objects consisting of: people, animals, aircraft, and ships.

Each physical property may be a physical property selected from the group of physical properties consisting of: absorption, albedo, angular momentum, area, brittleness, boiling point, capacitance, colour, concentration, density, dielectric, ductility, distribution, efficacy, elasticity, electric charge, electrical conductivity, electrical impedance, electric field, electric potential, emission, flexibility, flow rate, fluidity, frequency, hardness, inductance, intrinsic impedance, intensity, irradiance, length, location, luminance, luminescence, luster, malleability, magnetic field, magnetic flux, mass, melting point, moment, momentum, opacity, permeability, permittivity, plasticity, pressure, radiance, solubility, specific heat, resistivity, reflectivity, refractive index, spin, speed, strength, stiffness, temperature, tension, thermal conductivity, velocity, viscosity, volume, and wave impedance.

The step of performing a Gaussian Processes based Variational Bayes Expectation Maximisation process may comprise rotating and rebinning the object track data.

In a further aspect, the present invention provides apparatus for determining whether a provided object track is an abnormal object track, an object track being a set of values of one or more physical properties of an object measured over a period of time, a physical property of an object being any property that is measurable whose value describes the object's state, the apparatus comprising one or more processors arranged to: provide a model, the model comprising one or more functions, each function being representative of an object track that is defined to be normal, assign the provided object track to a function, and compare the provided object track to the function to which it has been assigned to determine whether or not that object track is an abnormal object track, wherein providing the model comprises: for each of a plurality of objects, determining an object track, wherein the determined object tracks are defined as normal object tracks, and using the determined object tracks, performing a Gaussian Processes based Variational Bayes Expectation Maximisation process to determine the one or more functions, each function being representative of one or more of the determined object tracks, the functions forming the model.

In a further aspect, the present invention provides apparatus for determining whether an object is behaving abnormally, the apparatus comprising: a tracking module configured to track the object to produce an object track, an object track being a set of values of one or more physical properties of an object measured over a period of time, a physical property of an object being any property that is measurable whose value describes the object's state, and apparatus operatively coupled to the tracking module and configured to determine whether the produced object track is an abnormal object track using a method according to any of the above aspects, thereby determining whether the object is behaving abnormally.

In a further aspect, the present invention provides apparatus for determining a model of normal object behaviour, the model being for use in a method of detecting abnormal object behaviour, the apparatus comprising: one or more sensors configured to, for each of a plurality of objects, over a period of time, measure values of one or more physical properties of an object, a physical property of an object being any property that is measurable whose value describes the object's state, and one or more processors operatively coupled to the one or more sensors and configured to: using some or all of the measurements, for each object, determine an object track, an object track being a set of values of the one or more physical properties of an object measured over the period of time, wherein the determined object tracks are defined as normal object tracks, and using the determined object tracks, perform a Gaussian Processes based Variational Bayes Expectation Maximisation process to determine the one or more functions, each function being representative of one or more of the object tracks, the functions forming the model.

In a further aspect, the present invention provides a model determined in accordance with any of the above aspects.

In a further aspect, the present invention provides a computer program or plurality of computer programs arranged such that when executed by a computer system it/they cause the computer system to operate in accordance with any of the above aspects.

In a further aspect, the present invention provides a machine readable storage medium storing a computer program or at least one of the plurality of computer programs according to the above aspect.

### BRIEF DESCRIPTION OF THE DRAWINGS

FIG. 1 is a schematic illustration (not to scale) of an example scenario in which an embodiment of a method of detecting abnormal behaviour is implemented;

FIG. 2 is a schematic illustration (not to scale) of a processor used to perform the method of detecting abnormal behaviour;

FIG. 3 is a process flow chart showing certain steps of a training process performed using the processor;

FIG. 4 is a schematic illustration (not to scale) of an image of an area and a plurality of determined tracks therein;

FIG. 5 is a schematic illustration (not to scale) of the image of the area and a plurality of determined generating functions therein;

FIG. 6 is a process flow chart showing certain steps of a method of determining the generating functions; and

FIG. 7 is a process flow chart showing certain steps of the method of detecting abnormal behaviour.

### DETAILED DESCRIPTION

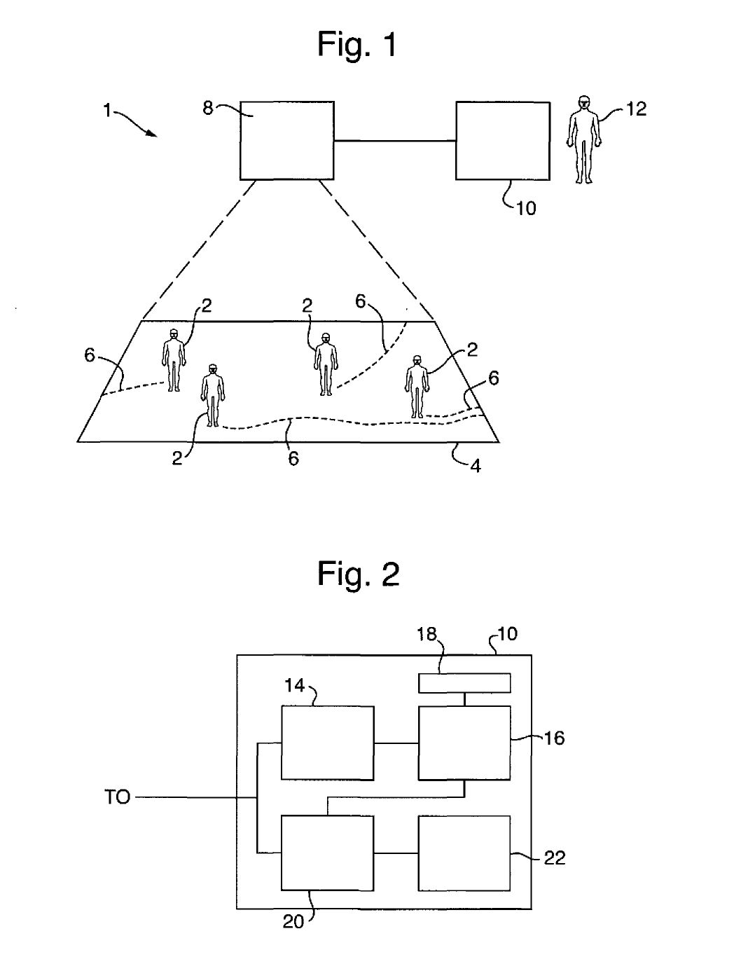

FIG. 1 is a schematic illustration (not to scale) of an example scenario 1 in which an embodiment of a method of detecting abnormal behaviour is implemented.

In the scenario 1, people 2 are moving within or through an area 4 (e.g. an area of terrain). The area 4 may be an indoor area (e.g. a room or corridor in a building) or an outdoor area (e.g. a street or plaza). As the people 2 move (e.g. walk, cycle etc.) within the area 4, each person 2 moves along a respective path (indicated in FIG. 1 by a dotted line and the reference numeral 6). For example, some people 2 may move through the area 4 along a path 6 (e.g. by entering the area 4 at one point along the boundary of the area 4, and exiting the area 4 at a different point along the boundary of the area 4).

Over a period of time, images of the area 4, and the people 2 moving within or through the area 4, are captured by a camera 8 (e.g. a closed-circuit television camera). The camera images are sent from the camera 8 to a processor 10.

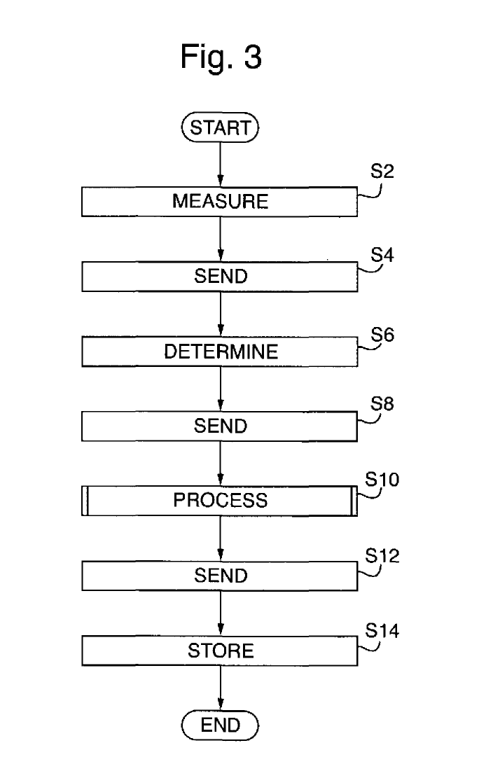

The processor 10 is described in more detail later below with reference to FIG. 2. The processor 10 processes the camera images received from the camera 8. In particular, the processor 10 performs the method of detecting abnormal behaviour using the camera images, as described in more detail later below with reference to FIGS. 3 to 7. The method of detecting abnormal behaviour is performed to detect people 2 within the area 4 who move along a path 6 that is abnormal. Definitions of what is a normal path and what is an abnormal path are determined by the processor 10 as described in more detail later below with reference to FIG. 3. The results of the method of detecting abnormal behaviour may then be provided (e.g. displayed) to an operator 12 (e.g. a human operator). The operator 12 may then perform an action depending on the displayed results.

FIG. 2 is a schematic illustration (not to scale) of an embodiment of the processor 10.

In this embodiment, the processor 10 comprises a people tracker 14, a learning and test module 16, a database 18, a frame processing module 20, and a display 22.

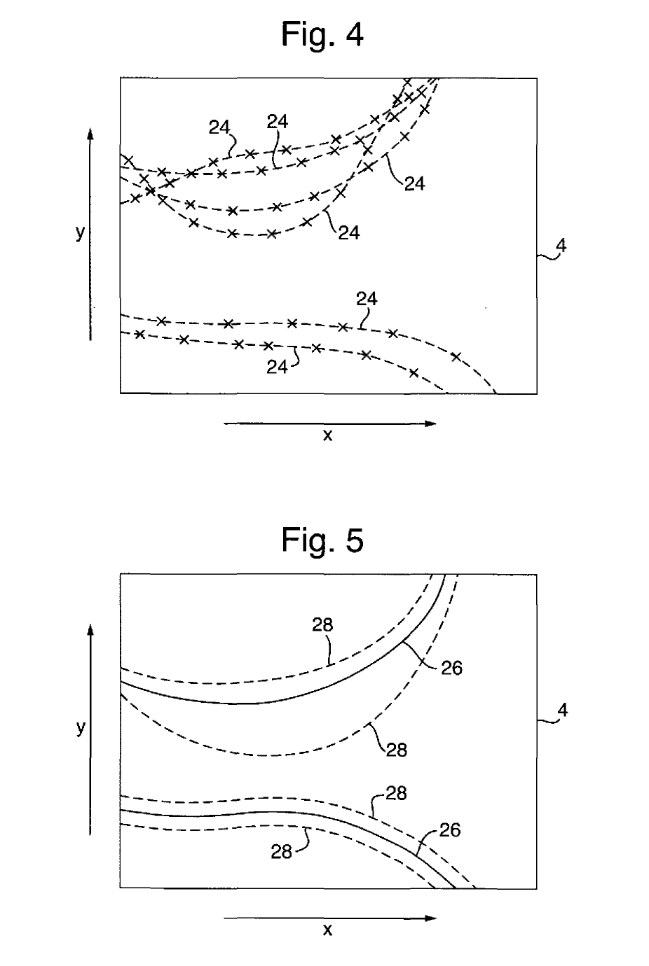

The people tracker 14 is configured to receive camera images sent to the processor 10 from the camera 8. As described in more detail later below with reference to FIGS. 3 and 4, the people tracker 14 is configured to process the received camera images using a conventional tracking algorithm. For example, a tracking algorithm such as that described in “Adaptive background mixture models for real-time tracking”, Chris Stauffer, Proceedings IEEE Conf. on Computer Vision and Pattern Recognition, pp. 246-252, 199 (which is incorporated herein by reference) may be used. This is performed to determine track data, or “tracks”, for each person 2 that moves through, or within, the area 4 during the time period over which the camera images were taken. These determined tracks are representative of the paths 6 along which the people 2 move through or within the area 4. For example, a track for a person 2 may be represented by a series of x- and y-positions of that person 2 within the area 4 over time. A track for a person 2 is a set of associated observations.

The people tracker 14 is further connected to the learning and test module 16 such that the output of the people tracker 14 (i.e. the determined tracks) may be sent from the people tracker 14 to the learning and test module 16.

The Learning and test module 16 is configured to process the received track information. Also, the learning and test module 16 is configured to operate in one of two modes. A first mode of the learning and test module 16 is hereinafter referred to as “training mode”. A second mode of the learning and test module 16 is hereinafter referred to as “test mode”.

As described in more detail later below with reference to FIG. 3, when operating in its training mode, the learning and test module 16 is configured to process the track information received from the people tracker 14 to determine (i.e. learn, estimate) one or more “generating functions” for the tracks. The determined generating functions are a mixture of Gaussian Processes (i.e. collections of stochastic variables whose outputs are jointly Gaussian distributed). The determined generating functions are those Gaussian Processes that best describe the observed data (i.e. the set of track data). The terminology “generating function” is used herein because the determined generating functions (drawn from a number of Gaussian Processes) may be thought of as functions that have generated the track data. The determination of generating functions is described in more detail later below.

As described in more detail later below with reference to FIG. 4, when operating in its test mode, the learning and test module 16 is configured to process the track information received from the people tracker 14 to produce a “score” value. In this embodiment, a score value for a track is a value that is indicative of how abnormal that track is, i.e. how abnormal the behaviour of the person 2 corresponding to that track is, i.e. how abnormal the path 6 that that person 2 moved along is.

The learning and test module 16 is coupled to the database 18 such that the generating functions (determined by the learning and test module 16 when it is operating in training mode) may be stored in the database 18, and such that generating functions stored in the database 18 may be retrieved by the learning and test module 16 (e.g. when the learning and test module 16 is operating in test mode).

The learning and test module 16 is further coupled to the frame processing module 20 such that the score values produced by the learning and test module 16 may be sent from the learning and test module 16 to the frame processing module 20.

In addition to being coupled to the learning and test module 16, frame processing module 20 is arranged to receive camera images sent to the processor 10 from the camera 8. As described in more detail later below with reference to FIG. 4, frame processing module 20 is configured to process the received camera images and the received score values. The frame processing module 20 is further coupled to the display 22 such that an output of the processing module 20 may be displayed (to the operator 12) on the display 22.

Apparatus, including the processor 10, for implementing the above arrangement, and performing the method steps to be described later below, may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

FIG. 3 is a process flow chart showing certain steps of a process performed by the camera 8 and the processor 10. In the process of FIG. 3, the learning and test module 16 of the processor is operating in training mode. Thus, the process of FIG. 3 is hereinafter referred to as the “training process”. In the training process, camera images are captured by the camera 8 (over a time period) and processed by the processor 10. This may be performed in real-time (i.e. the camera images may be processed by the processor 10 as they are captured by the camera 8), or not in real-time (e.g. the camera images may be taken over the time period, and then processed at a later time).

At step s2, the camera 8 captures images of the area 4. The images may include images of people 2 moving through and/or within the area 4.

At step s4, the camera 8 sends the images of the area 4 (and the people 2) to the people tracker 14 of the processor 10.

At step s6, the people tracker 14 performs a people tracking process on the camera images to determine a track (i.e. a set of track data) for each of the people 2 moving through or within the area 4 during the time period in which the camera images were taken at step s2. In this embodiment, a track for a person 2 is a series of x- and y-positions within the area 4, each position being the position of that person 2 within the area 4 at a particular time-step.

FIG. 4 is a schematic illustration (not to scale) of an image of the area 4 (for convenience and ease of understanding, the image of the area 4 is indicated by the same reference numeral as the area 4). FIG. 4 shows an example plurality of tracks 24. Each of the tracks 24 is a set of x- and y-positions (shown in FIG. 4 as crosses) that are joined together by a dotted line. Each track 24 is representative of a path 6 along which a person 2 moves through and/or within the area 4 during the time period in which the camera images were taken.

In this embodiment, a conventional people tracking algorithm is used by the people tracker 14 to determine the tracks.

At step s8, the tracks 24 are sent from the people tracker 14 to the learning and test module 16.

At step s10, the learning and test module 16 processes the received tracks 24 to determine one or more generating functions and associated parameters (e.g. length scale, scale factor etc.).

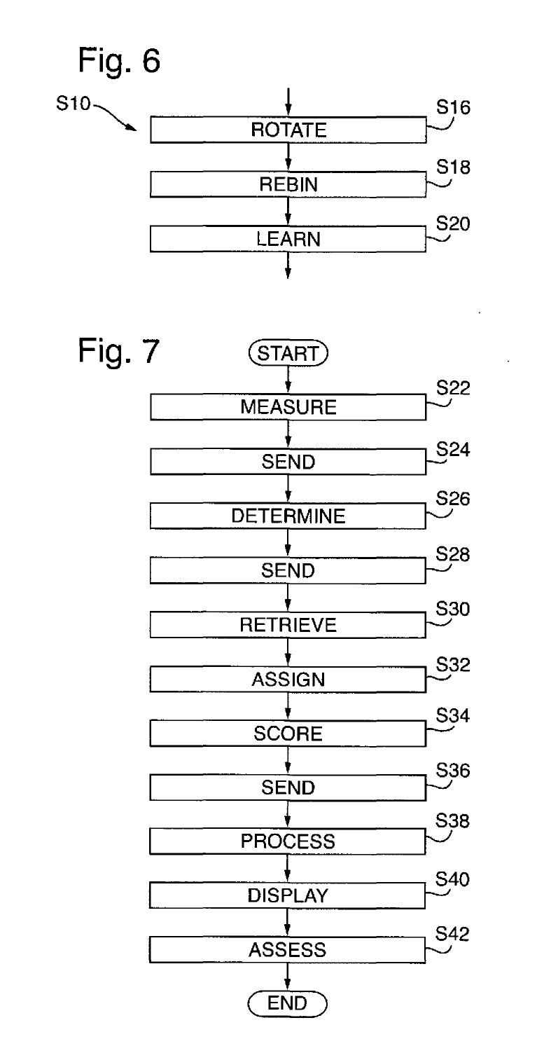

The process by which the learning and test module 16 processes the received tracks 24 to determine one or more generating functions is described in more detail later below with reference to FIG. 6.

The determined generating functions are components of a mixture of Gaussian Processes that describe (i.e. may be thought of as generating) the tracks 24.

Error bounds for each of the generating functions may also be determined at step s10.

FIG. 5 is a schematic illustration (not to scale) of the image of the area 4. FIG. 5 additionally shows an example plurality of generating functions (indicated in FIG. 5 by solid lines and the reference numeral 26) determined at step s10 for the tracks 24 shown in FIG. 4. The determined error bounds for the generating functions 26 are indicated in FIG. 5 by dotted lines and the reference numeral 28.

At step s12, the generating functions 26, corresponding error bounds 28, and other associated parameters that have been determined by the Learning and test module 16 are sent from the learning and test module 16 to the database 18.

At step s14, the generating functions 26, corresponding error bounds 28, and other associated parameters are stored at the database 18.

Thus, a training process is provided.

The generating functions 26 determined at step s10 of the training process and stored in the database 18 at step s14 of the training process form a model “normal behaviour” that has been learnt by the system. Thus, the generating functions 26 define what the processor 10 has learnt to be normal behaviour of the people 2 when moving through or within the area 4. As described in more detail later below with reference to FIG. 7, these generating functions 26 may be used to “test” tracks observed after the training process has been completed. This testing may be performed to determine, for each observed track, a score value that is indicative how normal (or abnormal) that track is. In other words, the generating functions 26 define normal/abnormal behaviour of people 2. The determined score values may be used to classify each of the observed tracks as being either normal or abnormal. Thus, the processor 10 is a Gaussian Process based classifier (that is trained, over a period of time, using the training process of FIG. 3).

FIG. 6 is a process flow chart showing certain steps of a process by which the learning and test module 16 processes the received tracks 24 to determine the one or more generating functions 26 (as performed at step s10 of the training process).

Steps s16 and s18 of the process of FIG. 6 describe optional pre-processing of the tracks 24.

At step s16, the tracks 26 are rotated. This may be performed to advantageously increase the baseline of the data, thereby allows for a more precise fit to the data.

At step s18, the rotated tracks 26 are rebinned. This may be performed such that the amount of data is reduced without losing important data. This advantageously tends to reduce the computation time of the training process.

At step s20, the generating functions 26 are learnt using a Gaussian Processes based Variational Bayes Expectation Maximisation process. In this process, Variational Bayes methods are applied to a mixture of Gaussian Processes to discern a number of generating functions 26.

The process implemented at step s20 may be performed as follows. Firstly, hyperparameters, functional membership probabilities, mean functions, and covariance functions for a mixture of Gaussian Processes may be initialised. An expectation maximisation process may then be iteratively performed until the increase (between the current iteration and the previous iteration) in the likelihood of the data being generated by the current mixture of Gaussian Processes (i.e. generating functions 26) is below a threshold value.

In other embodiments, the expectation maximisation process may be iteratively performed until a different criteria satisfied, e.g. until the likelihood of the data being generated by the mixture of Gaussian Processes (i.e. generating functions 26) is greater than a threshold value.

The process implemented at step s20 may be implemented in any appropriate way. For example, an algorithm such as that described in “Gaussian Process Segmentation of Co-Moving Animals” by Steven Reece, Richard Mann, lead Rezek, and Stephen Roberts (which is incorporated herein by reference) may be used. Using this algorithm, the tracks 26 are assigned to groups which may be used to specify the generating functions.

The Gaussian Processes based Variational Bayes Expectation Maximisation process advantageously assigns hyperparameters and group (i.e. generating function 26) membership simultaneously. Normality (i.e. normal behaviour of people 2 moving through or within the area 4) is represented by the (learnt) one or more groups (i.e. generating functions 260 and the (learnt) parameters for those groups (e.g. length scale, scale factor etc). These groups and associated parameters are stored in the database 18 (as described above with reference to step s14 of FIG. 3) for use in the classification process described in more detail later below with reference to FIG. 7.

Further information about Gaussian Processes based Variational Bayes Expectation Maximisation processes may be found in “Gaussian Process Segmentation of Co-Moving Animals” by Steven Reece, Richard Mann, lead Rezek, and Stephen Roberts and “Overlapping Mixtures of Gaussian Processes for the data association problem”, Miguel Lázaro-Gredilla, Steven Van Vaerenbergh, Neil D. Lawrence which are incorporated herein by reference.

Thus, a process by which the learning and test module 16 may process the tracks 24 to determine the one or more generating functions 26 is provided.

FIG. 7 is a process flow chart showing certain steps of a method of detecting abnormal behaviour amongst people 2 moving through or within the area 4. In the process of FIG. 7, the learning and test module 16 of the processor 10 operates in test mode. Thus, the process of FIG. 7 is hereinafter referred to as the “test process”. In this embodiment, the test process may be performed after the training process (described above with reference to FIG. 3) has been completed. In the test process, camera images are captured by the camera 8 (over a time period) and processed by the processor 10. Advantageously, this may be performed in real-time (i.e. the camera images may be processed by the processor 10 as they are captured by the camera 8) so that abnormal behaviour of a person 2 may be detected and displayed to the operator 12 in real-time.

At step s22, the camera 8 captures images of the area 4. This is performed in the same way as step s2 of the process of FIG. 3, but for a later time period.

At step s24, the camera 8 sends the images of the area 4 (and the people 2) to both the people tracker 14 and the frame processing module 20.

At step s26, the people tracker 14 performs a people tracking process on the camera images to determine a track (i.e. a set of track data) for each of the people 2 moving through or within the area 4 during the time period in which the camera images were taken at step s22.

In this embodiment, the same people tracking algorithm is used (by the people tracker 14 to determine the tracks 26) at both steps s26 and s6.

The tracks determined at step s26 are to be “tested”, i.e. compared against the stored generating functions 26, to determine a score value that is indicative of how abnormal that track is. Thus, the tracks determined at step s26 are hereinafter referred to “test tracks”.

At step s28, the test tracks are sent from the people tracker 14 to the learning and test module 16.

At step s30, the learning and test module 16 retrieves, from the database 18, the generating functions 26, corresponding error bounds 28, and other associated parameters that were stored in the database 18 at step s14 of the training process.

At step s32, the learning and test module 16 assigns each of the test tracks to the generating function 26 that is most likely to have generated that test track.

This assignment of each of the test tracks to a generating function 26 may be performed using any appropriate method. For example, “Gaussian Process Segmentation of Co-Moving Animals” by Steven Reece, Richard Mann, lead Rezek, and Stephen Roberts (which is incorporated herein by reference) describes a process of determining path (i.e. test track) to group (i.e. generating function 26) assignment probabilities. Using these probabilities, a test track may be assigned to a generating function, e.g. by assigning the test track to the generating function corresponding to the highest assignment probability.

At step s34, for each of the test tracks, the learning and test module 16 determines a score value that is indicative of how abnormal that test track is when compared to the generating function 26 to which that test track has been assigned.

This determination of a score value may be computed in any appropriate way. For example, score value for a test track may be equal to, or some function of, the Mahalanobis distance between the test track and the generating function 26 to which that test track has been assigned. Further discussion of the Mahalanobis distance can be found at “On the generalised distance in statistics”. Mahalanobis, Prasanta Chandra (1936). Proceedings of the National Institute of Sciences of India 2 (1): 49-55 which is incorporated herein by reference. In such an embodiment, a relatively large distance between the test track and the generating function 26 to which it has been assigned may indicate that that test track is unlikely to have been generated by that generating function 26, i.e. the that test track is abnormal. In contrast, a relatively small distance between the test track and the generating function 26 to which it has been assigned may indicate that that test track is likely to have been generated by that generating function 26, i.e. the that test track is normal. In other embodiments, the score of a test track may be dependent upon the values of one or more other parameters instead of or in addition to the Mahalanobis distance, e.g. using units of variance, standard deviation, and/or likelihood.

In other embodiments, steps s32 and s34 may be performed together (i.e. simultaneously) e.g. by calculating an assignment probability for each of the generating functions 26. These calculated values may then be used as the score values.

At step s36, the test tracks and corresponding score information are sent from the learning and test module 16 to the frame processing module 20.

At step s38, the frame processing module 20 processes the received camera images (sent to the frame processing module 20 at step s22 from the camera 8) and the received test tracks and corresponding score information (sent to the frame processing module 20 at step s34 from the learning and test module 16).

At step s40, some or all of the processed information is displayed by the frame processing module 20 on the display 22 to the operator 12. The processed information may be displayed using a graphical user interface (GUI) that allows the operator 12 to interact with, and manipulate, the displayed information.

For example, the area 4 and people moving through or within the area may be displayed to the operator, using a GUI, in real-time. The GUI may include a feature that allows the operator 12 to change the opacity of the images of the people 2 depending on the score values associated with those people 2. For example, the opacity of people 2 that are deemed to be behaving normally may be reduced and/or the opacity of people 2 that are deemed to be behaving abnormally may be increased. Thus, a person 2 whose behaviour is abnormal may be highlighted by the operator 12 and displayed to the operator 12 so that, e.g. the operator may more closely monitor the behaviour of that person 2. This feature of allowing the operator 12 to change the image opacity of a person 2 depending on how normally that person 2 is behaving many be facilitated by providing a slider on the GUI that the operator 2 may move to change image opacity.

At step s42, the operator 12 assesses the displayed information and may act accordingly.

For example, the operator 12 may determine that the behaviour of a person 2 is actually normal when it has been classified by the system as being abnormal (or vice versa). In this case, the operator 12 may indicate (i.e. manually classify) that person's behaviour as normal (or abnormal). In other words, the operator may manually classify a path 6 that a person 2 follows as being normal or abnormal. Such manual classifications may be used to retrain the Gaussian Process based-classifier (i.e. the manual classifications may be reused to learn a new set of generating functions 26, or update the existing generating functions 26).

Also for example, the operator 12 may determine that the behaviour of a person 2 that has been classified as being abnormal is indeed abnormal. In this case, the operator 12 may act accordingly. For example, the operator 12 may perform actions so as to prevent the person 2 who is behaving abnormally from continuing to behave abnormally, the operator 12 may alert a third party, the operator 12 may raise an alarm etc.

Thus, a test process is provided.

The above described system and methods advantageously tend to provide an automatic and unsupervised learning method/algorithm for modelling normality. In particular, using the camera images, the processor 10 may learn/generate one or more generating functions for the observed tracks. These generating functions advantageously tend to provide a model of normality in the system (i.e. a model of the paths 6 people 2 moving through or within the area 4 normally follow).

Also, the above described system and methods advantageously tend to automatically determine that a deviation from normality has occurred. This may be easily indicated to a human operator. This advantageously tends to facilitate in the detection of abnormal behaviour. Also, this advantageously tends to facilitate in the analysis of (e.g. large sets of) surveillance data e.g. by a human operator. The determination that a deviation from normality has occurred may be performed in real-time.

Advantageously, the indication that the behaviour of an entity (i.e. a track) is abnormal when it is in fact normal tends not to be particularly problematical. An operator may manually classify as normal the track that was originally classified as abnormal. This may then be used to retrain the Gaussian processes based classifier, thereby advantageously reducing the likelihood of such an error reoccurring. Furthermore, the number of such false classifications tends to manageable.

The people tracker advantageously tends to extract uniquely identified target tracks from the camera images.

Advantageously, using the GUI, the operator may change the opacity of the images of the people/tracks depending on the score values associated with those people. For example, the opacity of all foreground objects may be decreased, whilst full opacity may be maintained for objects with anomalous tracks. Thus, the workload of the operator tends to be reduced by hiding normality whilst highlighting abnormal behaviour. This may be implemented by use of one or more slider features for the GUI that allows the operator to customise the opacity of objects having normal tracks and/or abnormal tracks. Another slider feature may be used to allow the operator to navigate video footage containing abnormal behaviours.

Advantageously, the above described method for detecting abnormal behaviour is a non-parametric method. A definition of normality does not need to be provided. Instead, the system learns a definition of normality that is then used to detect abnormal behaviour. This tends to be in contrast to many conventional methods which may require a definition of normality to be provided, e.g. by domain experts. Such conventional methods tend to be limited by what abnormal behaviours are (or can be) defined.

It should be noted that certain of the process steps depicted in the flowchart of FIGS. 3 and 7 and described above may be omitted or such process steps may be performed in differing order to that presented above and shown in FIGS. 3 and 7. Furthermore, although all the process steps have, for convenience and ease of understanding, been depicted as discrete temporally-sequential steps, nevertheless some of the process steps may in fact be performed simultaneously or at least overlapping to some extent temporally.

In the above embodiments, the methods and system for detecting abnormal behaviour are implemented in the scenario of FIG. 1. However, in other embodiments, the methods and system for detecting abnormal behaviour are implemented in a different scenario.

In the above embodiments, abnormal behaviour of people moving within an area is detected, i.e. the movement of a person along an abnormal or anomalous path is detected. However, in other embodiments, the abnormal behaviour detection system and methods are implemented to detect abnormal behaviour of different objects, for example, animals, or vehicles (e.g. aircraft, ships etc.).

In the above embodiments, a track of an object is represented by a series of x- and y-positions of that object within an area. However, in other embodiments, a track of an object is a set of different associated observations, i.e. measurements of different physical properties of that object. The terminology “physical property of an object” is used herein to refer to any property that is measurable whose value describes the object's state. For example, in other embodiments, one or more of the following other physical properties of an object may be measured and used to produce a track for that object: absorption (physical and/or electromagnetic), albedo, angular momentum, area, brittleness, boiling point, capacitance, colour, concentration, density, dielectric, ductility, distribution, efficacy, elasticity, electric charge, electrical conductivity, electrical impedance, electric field, electric potential, emission, flexibility, flow rate, fluidity, frequency, hardness, inductance, intrinsic impedance, intensity, irradiance, length, location, luminance, luminescence, lustre, malleability, magnetic field, magnetic flux, mass, melting point, moment, momentum, opacity, permeability, permittivity, plasticity, pressure, radiance, solubility, specific heat, resistivity, reflectivity, refractive index, spin, speed, strength, stiffness, temperature, tension, thermal conductivity, velocity, viscosity, volume, wave impedance.

In the above embodiments, camera images of the objects are used in the detection of abnormal behaviour. However, in other embodiments the observations of the objects may be in a different form e.g. Automatic Identification System (AIS) data, a stream of GPS data, radar images, infrared images etc.

In the above embodiments, the test process is performed in real-time. However, in other embodiments, the test process is not performed in real-time.

In the above embodiments, at step s20 of the method of FIG. 6, the generating functions are learnt using a Gaussian Processes based Variational Bayes Expectation Maximisation process. However, in other embodiments a different method of learning a model of normality may be used. For example, in other embodiments a K-means clustering method may be used. Also for example, in other embodiments a simple Bayesian method may be used. However, in such other embodiments it may be necessary to specify a number of generating functions to be determined/learnt. Advantageously, a Gaussian Processes based Variational Bayes Expectation Maximisation process tends not to require the specification of the number of generating functions. Instead, the number of generating functions tends to be learnt by the system.

1. A method of determining whether a provided object track is an abnormal object track, an object track being a set of values of one or more physical properties of an object measured over a period of time, a physical property of an object being any property that is measurable whose value describes the object's state, the method comprising:
providing a model, the model comprising one or more functions, each function being representative of an object track that is defined to be normal;
assigning the provided object track to a function; and
comparing the provided object track to the function to which it has been assigned to determine whether or not that object track is an abnormal object track;
wherein providing the model comprises:
for each of a plurality of objects, determining an object track, wherein the determined object tracks are defined as normal object tracks; and
using the determined object tracks, performing a Gaussian Processes based Variational Bayes Expectation Maximisation process to determine the one or more functions, each function being representative of one or more of the determined object tracks, the functions forming the model.

2. A method according to claim 1, wherein the comparing comprises using the provided object track and the function to which it has been assigned and determining a score value that is indicative of how abnormal the provided object track is, relative to the function to which it has been assigned.

3. A method according to claim 2, wherein determining the score value comprises determining the Mahalanobis distance between the provided object track and the function to which it has been assigned.

4. A method according to claim 1, the method further comprising displaying the provided object track with an image opacity that is dependent upon how abnormal the provided object track is, relative to the function to which it has been assigned.

5. A method of determining whether an object is behaving abnormally, the method comprising:
tracking the object to produce an object track, an object track being a set of values of one or more physical properties of an object measured over a period of time, a physical property of an object being any property that is measurable whose value describes the object's state; and
determining whether the produced object track is an abnormal object track using a method according to claim 1, thereby determining whether the object is behaving abnormally.

6. A method of determining a model of normal object behaviour, the model being for use in a method of detecting abnormal object behaviour, the method comprising:
for each of a plurality of objects, over a period of time, measuring values of one or more physical properties of that object, a physical property of an object being any property that is measurable whose value describes the object's state;
using some or all of the measurements, for each object, determining an object track, an object track being a set of values of the one or more physical properties of an object measured over the period of time, wherein the determined object tracks are defined as normal object tracks; and
using the determined object tracks, performing a Gaussian Processes based Variational Bayes Expectation Maximisation process to determine the one or more functions, each function being representative of one or more of the object tracks, the functions forming the model.

7. A method according to claim 6, wherein determining an object track for an object comprises performing a tracking algorithm to track that object over the period of time.

8. A method according to claim 7, wherein the tracking algorithm is performed using measurements, taken over the period of time, of the one or more physical properties of each of the plurality of objects.

9. A method according to claim 8, wherein each measurement is a measurement including at least one of: camera images, Automatic Identification System data, Global Positioning System data, and radar images.

10. A method according to claim 6, wherein each of the objects is selected from the group of objects including: people, animals, aircraft, and ships.

11. A method according to claim 6, wherein each physical property is selected from the group: absorption, albedo, angular momentum, area, brittleness, boiling point, capacitance, colour, concentration, density, dielectric, ductility, distribution, efficacy, elasticity, electric charge, electrical conductivity, electrical impedance, electric field, electric potential, emission, flexibility, flow rate, fluidity, frequency, hardness, inductance, intrinsic impedance, intensity, irradiance, length, location, luminance, luminescence, lustre, malleability, magnetic field, magnetic flux, mass, melting point, moment, momentum, opacity, permeability, permittivity, plasticity, pressure, radiance, solubility, specific heat, resistivity, reflectivity, refractive index, spin, speed, strength, stiffness, temperature, tension, thermal conductivity, velocity, viscosity, volume, and wave impedance.

12. A method according to claim 6, wherein performing a Gaussian Processes based Variational Bayes Expectation Maximisation process comprises rotating and rebinning object track data.

13. Apparatus for determining whether a provided object track is an abnormal object track, an object track being a set of values of one or more physical properties of an object measured over a period of time, a physical property of an object being any property that is measurable whose value describes the object's state, the apparatus comprising one or more processors arranged to:
provide a model, the model comprising one or more functions, each function being representative of an object track that is defined to be normal;
assign the provided object track to a function; and
compare the provided object track to the function to which it has been assigned to determine whether or not that object track is an abnormal object track;
wherein providing the model comprises:
for each of a plurality of objects, determining an object track, wherein the determined object tracks are defined as normal object tracks; and
using the determined object tracks, performing a Gaussian Processes based Variational Bayes Expectation Maximisation process to determine the one or more functions, each function being representative of one or more of the determined object tracks, the functions forming the model.

14. Apparatus for determining a model of normal object behaviour, the model being for use in a method of detecting abnormal object behaviour, the apparatus comprising:
one or more sensors configured, for each of a plurality of objects, over a period of time, to measure values of one or more physical properties of that object, a physical property of an object being any property that is measurable whose value describes the object's state; and
one or more processors operatively coupled to the one or more sensors and configured to:
determine an object track, using some or all of the measurements, for each object, an object track being a set of values of the one or more physical properties of an object measured over the period of time, wherein the determined object tracks are defined as normal object tracks; and
perform a Gaussian Processes based Variational Bayes Expectation Maximisation process, using the determined object tracks, to determine the one or more functions, each function being representative of one or more of the object tracks, the functions forming the model.

15. A non-transient computer program or plurality of computer programs arranged such that when executed by a computer system it/they cause the computer system to operate in accordance with the method of claim 1.

16. A non-transient computer program or plurality of computer programs arranged such that when executed by a computer system it/they cause the computer system to operate in accordance with the method of claim 6.

17. A method according to claim 1, wherein determining an object track for an object comprises performing a tracking algorithm to track that object over the period of time.

18. A method according to claim 1, wherein each of the objects is selected from the group of objects including: people, animals, aircraft, and ships.

19. A method according to claim 1, wherein each physical property is selected from the group: absorption, albedo, angular momentum, area, brittleness, boiling point, capacitance, colour, concentration, density, dielectric, ductility, distribution, efficacy, elasticity, electric charge, electrical conductivity, electrical impedance, electric field, electric potential, emission, flexibility, flow rate, fluidity, frequency, hardness, inductance, intrinsic impedance, intensity, irradiance, length, location, luminance, luminescence, lustre, malleability, magnetic field, magnetic flux, mass, melting point, moment, momentum, opacity, permeability, permittivity, plasticity, pressure, radiance, solubility, specific heat, resistivity, reflectivity, refractive index, spin, speed, strength, stiffness, temperature, tension, thermal conductivity, velocity, viscosity, volume, and wave impedance.

20. A method according to claim 1, wherein performing a Gaussian Processes based Variational Bayes Expectation Maximisation process comprises rotating and rebinning object track data.
